(19) United States
(12) Patent Application Publication
(10) Pub. No.: US 2009/0139093 A1
(43) Pub. Date: Jun. 4, 2009

(54) Split, reciprocating, hair cutting comb

(76) Inventor: Ronald Moreschini, Pueblo, CO (US)

Correspondence Address: RONALD MORESCHINI D.D.S., 2938 HIGH AVE., PUEBLO, CO, 81008, US

(21) Appl. No.: 11/998,786

(22) Filed: Dec. 3, 2007

(51) Int. Cl. B26B 21/12; A45D 24/10

(52) U.S. Cl. 30/30; 132/148

(57) ABSTRACT

This invention is a unique “split” comb, fitted with moveable teeth, giving said comb the ability to cut any hair, that happens to fall between the teeth of said comb, at the touch of an activating button, located near the handle of said comb, making it a “hair-cutting” comb. It is easily manipulated, using one hand only, it can lift the hair to a ninety degree angle to the scalp, slide outward to the desired length of the hair, and then cut the hair, eliminating the use of a pair of scissors, making it possible for the average individual to look in a mirror, and cut his or her own hair, also making it much easier for a professional barber or beautician to cut and style hair, while almost eliminating the use of scissors.

### BACKGROUND OF THE INVENTION

This invention relates to devices used in the barber profession and more specifically used in cutting hair.

As part of the barber profession a comb is used to comb, move, arrange and style the hair. It is also used to lift and hold the hair at a ninety-degree angle to the surface of the scalp, and at the desired length, where a pair of scissors then cuts it. When the comb is removed the hair falls down against the scalp in a desired taper.

A common problem with the known device of conventional type is the difficulty in using a pair of scissors to cut the hair, especially at the top portion of the head where the hair is relatively long and the barber must put down the scissors in his right hand, then hold the comb with his right hand, then reach up and hold the long hair between two fingers of his left hand, then pick up the scissors again in his right hand and cut the hair at the desired length. This complicated step must be done again and again during an average hair cutting procedure.

### BRIEF SUMMARY OF THE INVENTION

This invention is an improvement on the old conventional type comb as it can eliminate the need for a pair of scissors while giving a person a hair-cut. The new invention is a comb and scissors combined into a single tool. This invention looks like the old barber type comb in size and shape, but now, instead of being made of a hard rubber it is made of fine surgical steel, instead of being in one piece it is now in two identical, mirror images of each other. It might be better described as a typical comb that has been “split” down the center from the top or back of the comb down to the tip of each tooth for the entire length of the comb. Creating two half combs that fit together to make one complete comb. One of the half combs is fitted with a handle and an activating device. The two half combs each have a smooth flat inner surface that fit together and slide back and forth causing one tooth to slide past another in a small reciprocating motion cutting any hair laying between any two teeth of the comb. The outer surfaces of the comb are the same shape of the rounded teeth of the typical comb. The two half sections of the “split” comb are held together by two slots in one half section through which two studs on the other half section pass through and held together by a spring loaded connector. One half of the “split” comb can be activated at will by a mechanical or manual device. The invention can be used as an ordinary comb but with the added advantage that when the hair is lifted away from the scalp by the comb, and slid to the desired length, the present invention would be activated, causing the movable half section to move forward about three sixteenth of an inch, cutting the hair. When the activating device is released the movable half section, is returned to its original position by a spring, lining up all the teeth, returning the present invention back into a comb.

### OBJECT OF THE PRESENT INVENTION

An object of the present invention is to provide a comb that can cut hair.

Another object of the present invention is to provide a hair-cutting comb so a person at home using a mirror could easily cut or trim his own hair.

Another object of the present invention is to provide a hair-cutting comb that will make it possible for professional barbers to eliminate many tedious movements in giving a person a hair cut.

Another object of the present invention is to eliminate or reduce the need of a pair of scissors in giving a hair cut.

Another object of the present invention is to provide a hair-cutting comb that can be used as an ordinary standard comb, to comb, move, arrange, lift and style hair, and also be activated at will to cut the hair it is lifting and holding at the desired length without using a pair of scissors.

These and other objects and advantages of this invention will become apparent upon reading the following descriptions of which the attached drawing form a part.

### BRIEF DESCRIPTION OF THE DRAWING

FIG. 1, Is an exploded perspective view of the present invention.

### REFERRING TO THE DRAWING

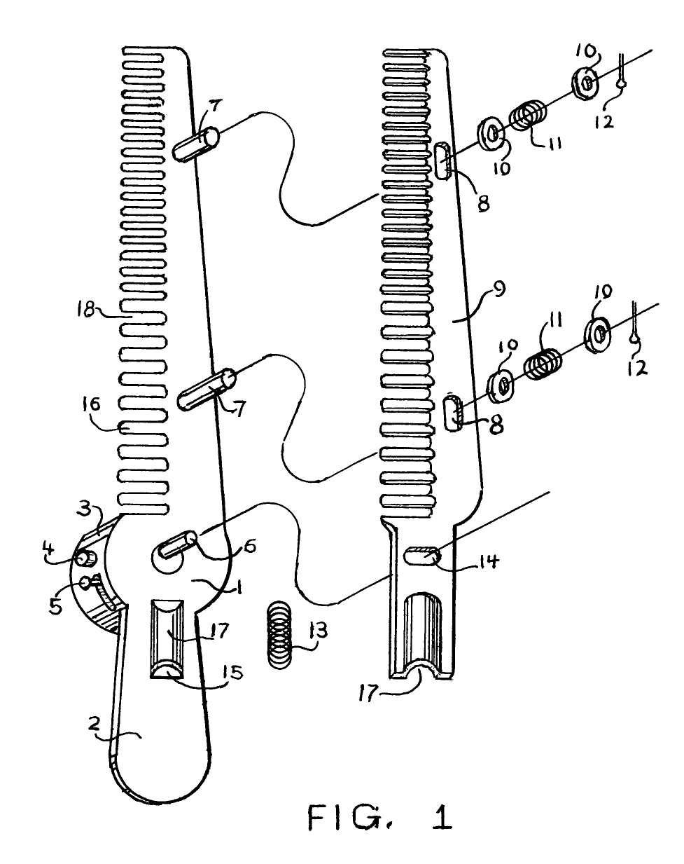

In FIG. 1, we see one half of the split comb 1, fitted with a handle 2. FIG. 1, Also shows an electric motor 3, with an off center shaft 6. Also seen in FIG. 1, is a push button on/off switch 4, that activates the electric motor 3. Also seen in FIG. 1, is the automatic, semi-automatic selector switch control lever 5, that will control how many revolutions the off center motor shaft 6, will complete when the push button on/off switch 4, is activated. In the automatic mode, the electric motor 3, and the off center motor shaft 6, continues to rotate until the on/off push button 4, is released, stopping the electric motor 3, In the semi-automatic mode, the electric motor 3, and the off center motor shaft 6, shaft will make only one revolution and then stop. The on/off button 4, must be released, and then pushed again to activate it once more. FIG. 1, also shows the two studs 7, that fit through the two slots 8, in the second, or other half 9, of the hair cutting comb and the four washers 10, and the two springs 11, that will hold the two halves 1, and 9, together with spring loaded force when held together with the cotter pins 12. Also seen in FIG. 1, is the slot 14, through which the off center motor shaft 6, fits into and when rotated by the electric motor 3, will drive the second or other half 9, of the hair cutting comb in a reciprocating motion, causing all the split teeth 16, of the assembled hair cutting comb to slide back and forth past one another, cutting any hair that comes between them. Also seen in FIG. 1, is the spring 13, supported by the boss 15, and enclosed by the two half channel 17, located in the two halves l,and 9, so that when the two halves 1, and 9, of the hair cutting comb are assembled, spring 13, will spring load the two halves 1, and 9, of the hair-cutting comb so that when the motor 3, stops rotating, the two half sections 1, and 9, of the hair cutting comb, are forced to a stable, passive position with all of the teeth 16, from both half sections 1, and 9, directly opposite of each other, thereby opening the spaces 18, between all of the teeth 16, so that the hair-cutting comb has become a fully functional comb once again. It is understood that a simple, manually operated, spring-loaded lever could be used to activate the reciprocal action of the second half 9, instead of the electric motor 3.

This invention may be further developed within the scope of the following claims, accordingly, it is desired that the fore going description be read merely as being illustrative of an operative embodiment of this invention and not a strictly limiting sense.

What is claimed is:

1. A hair-cutting comb comprising:
Two surgical steel identically shaped combs, (with a handle and motor fitted to one of them) fitted together with precision ground flat opposing surfaces held together with spring loaded connectors in such a way that they may slide back and forth against one another in a controlled Reciprocating manner for about three sixteenth of an inch.

2. A hair cutting comb as set forth in claim 1. wherein said hair-cutting Comb has a switch for either automatic or semi automatic mode.

3. A hair cutting comb as set forth in claim 2. wherein the selection mode “automatic” is selected, and the hair-cutting comb activated, by pushing an on/off button, the hair-cutting comb will continue to reciprocate and cut hair as long as the on/off button is held down.

4. A hair-cutting comb as set forth in claim 3. wherein the selection mode “semi automatic” is selected, and the hair-cutting comb activated, by pushing the on/off button, the hair-cutting comb will reciprocate only one time.

5. A hair-cutting comb as set forth in claim 4. wherein after the hair-cutting comb has been activated and then stopped, the spring loaded reciprocating half comb will automatically be moved to a neutral or passive position where all the teeth in both combs are directly opposite one another thus opening all the spaces between the teeth of both combs, turning the hair-cutting comb back into a normal fully functioning common comb.

6. A hair-cutting comb as set forth in claim 5, wherein the hair can be lifted up to a ninety degree angle to the scalp, by the hair-cutting comb, and then cut the hair by touching a button and activating the cutting action of the hair-cutting comb.

7. A hair-cutting comb as set forth in claim 6, wherein the hair cutting comb can lift the hair up and away from the head to a ninety degree angle to the scalp, then drawn away from the scalp to the desired length, and then cut the hair by activating the hair-cutting ability of the hair-cutting comb.

8. A hair-cutting comb as set forth in claim 7, wherein said hair-cutting comb can be manipulated by one hand only, thus making it possible, for the average person to look in a mirror and trim or cut his own hair.

9. A hair-cutting comb as set forth in claim 8, wherein said hair-cutting comb is activated by a simple, hand operated, spring loaded lever, instead of an electric motor.
